(19) United States
(12) Patent Application Publication
(10) Pub. No.: US 2023/0229391 A1
(43) Pub. Date: Jul. 20, 2023

(54) NORMALIZER FOR PERFORMING NORMALIZATION AND DENORMALIZATION ON FLOATING-POINT DATA AND OPERATION CIRCUIT INCLUDING THE SAME

(71) Applicant: SK hynix Inc., Icheon-si Gyeonggi-do (KR)

(72) Inventor: Sang Hoon OH, Icheon-si Gyeonggi-do (KR)

(73) Assignee: SK hynix Inc., Icheon-si Gyeonggi-do (KR)

(21) Appl. No.: 17/837,997

(22) Filed: Jun. 10, 2022

(30) Foreign Application Priority Data
Jan. 19, 2022 (KR) 10-2022-0008143

(51) Int. Cl. G06F 5/01

(52) U.S. Cl. CPC G06F 5/012

(57) ABSTRACT

A normalizer receives input data including first exponent data and first mantissa data and generates normalized output data. The normalizer includes a mantissa alignment circuit, a “1” search circuit, an exponent addition circuit, a normalization circuit. The mantissa alignment circuit outputs second mantissa data including a binary point shifted by one bit to the left in comparison to a binary point of the first mantissa data. The “1” search circuit searches for an uppermost bit position of a leading “1” in the second mantissa data to output shift data. The exponent addition circuit performs an addition operation on the shift data and the first exponent data and configured to perform a “+1” operation on a result of the addition operation to output addition data. The normalization circuit performs normalization when the addition data corresponds to a normalization condition, the normalization being performed by outputting the addition data as exponent data of the output data and outputting result data that is obtained by shifting the second mantissa data by the number of bits that correspond to an absolute value of the shift data as mantissa data of the output data.

### CROSS REFERENCE TO RELATED APPLICATIONS

The present application claims priority under 35 U.S.C. 119(a) to Korean Patent Application No. 10-2022-0008143, filed on Jan. 19, 2022, which is incorporated herein by reference in its entirety.

### BACKGROUND

### 1. Technical Field

Various embodiments of the present disclosure relate to normalizers, and more particularly, to normalizers for performing normalization and denormalization on floating point data, and an operation circuit including the same.

### 2. Related Art

In general, floating-point arithmetic operation is performed according to the IEEE754 standard. The IEEE754 standard defines various floating-point numbers including sign, exponent, and mantissa. For these various floating-point numbers, the standard form for the mantissa contains a leading “1” so that normalization for the mantissa is always required. In general, the normalization may be performed by searching for a leading “1” and performing shifting on the mantissa based on the result. As a result of the arithmetic operation on floating-point data, result data including exponent data having a value smaller than “0” may be generated. In this case, it is necessary to perform denormalization for the result data to convert the format of the result data into a denormalized format in which the exponent is fixed to “0” and the hidden bit is “0”.

### SUMMARY

A normalizer according to an embodiment of the present disclosure may receive input data including first exponent data and first mantissa data and generate normalized output data. The normalizer may include a mantissa alignment circuit, a “1” search circuit, an exponent addition circuit, and a normalization circuit. The mantissa alignment circuit may output second mantissa data including a binary point shifted by one bit to the left in comparison to a binary point of the first mantissa data. The “1” search circuit may search for an uppermost bit position of a leading “1” in the second mantissa data to output shift data. The exponent addition circuit may perform an addition operation on the shift data and the first exponent data and configured to perform a “+1” operation on a result of the addition operation to output addition data. The normalization circuit may perform normalization when the addition data corresponds to a normalization condition, the normalization being performed by outputting the addition data as exponent data of the output data and outputting result data that is obtained by shifting the second mantissa data by the number of bits that correspond to an absolute value of the shift data as mantissa data of the output data.

An operation circuit according to an embodiment of the present disclosure may include a multiplier configured to perform a multiplication operation on first input data and second input data in a floating-point format to output multiplication data including first exponent data and first mantissa data, and a normalizer configured to receive the multiplication data and generate and output normalized output data. The normalizer may include a mantissa alignment circuit, a “1” search circuit, an exponent addition circuit, and a normalization circuit. The mantissa alignment circuit may output second mantissa data, a binary point of the second mantissa data being shifted by one bit to the left in comparison to a binary point of the first mantissa data. The “1” search circuit may search for an uppermost bit position of a leading “1” in the second mantissa data to output shift data. The exponent addition circuit may perform an addition operation on the shift data and the first exponent data and configured to perform a “+1” operation on a result of the addition operation to output addition data. The normalization circuit may perform normalization when the addition data corresponds to a normalization condition, the normalization being performed by outputting the addition data as exponent data of the output data and outputting result data that is obtained by shifting the second mantissa data by the number of bits that correspond to an absolute value of the shift data as mantissa data of the output data.

### BRIEF DESCRIPTION OF THE DRAWINGS

Certain features of the disclosed technology are illustrated by various embodiments with reference to the attached drawings.

FIG. 1 is a diagram illustrating a normalizer according to an embodiment of the present disclosure.

FIG. 2 is a diagram illustrating an example of a configuration of an exponent addition circuit of the normalizer of FIG. 1.

FIG. 3 is a diagram illustrating an operation circuit according to an embodiment of the present disclosure.

FIG. 4 is a diagram illustrating an example of a configuration of a multiplier of the operation circuit of FIG. 3.

FIGS. 5 and 6 are diagrams illustrating an example of an operation of the operation circuit of FIG. 3.

FIGS. 7 and 8 are diagrams illustrating another example of the operation of the operation circuit of FIG. 3.

FIGS. 9 and 10 are diagrams illustrating further another example of the operation of the operation circuit of FIG. 3.

### DETAILED DESCRIPTION OF THE EMBODIMENTS

In the following description of embodiments, it will be understood that the terms “first” and “second” are intended to identify elements, but not used to define a particular number or sequence of elements. In addition, when an element is referred to as being located “on,” “over,” “above,” “under,” or “beneath” another element, it is intended to mean relative positional relationship, but not used to limit certain cases for which the element directly contacts the other element, or at least one intervening element is present between the two elements. Accordingly, the terms such as “on,” “over,” “above,” “under,” “beneath,” “below,” and the like that are used herein are for the purpose of describing particular embodiments only and are not intended to limit the scope of the present disclosure. Further, when an element is referred to as being “connected” or “coupled” to another element, the element may be electrically or mechanically connected or coupled to the other element directly, or may be electrically or mechanically connected or coupled to the other element indirectly with one or more additional elements between the two elements.

Moreover, when a parameter is referred to as being “predetermined,” it may be intended to mean that a value of the parameter is determined in advance of when the parameter is used in a process or an algorithm. The value of the parameter may be set when the process or the algorithm starts or may be set during a period in which the process or the algorithm is executed. A logic “high” level and a logic “low” level may be used to describe logic levels of electric signals. A signal having a logic “high” level may be distinguished from a signal having a logic “low” level. For example, when a signal having a first voltage corresponds to a signal having a logic “high” level, a signal having a second voltage may correspond to a signal having a logic “low” level. In an embodiment, the logic “high” level may be set as a voltage level which is higher than a voltage level of the logic “low” level. Meanwhile, logic levels of signals may be set to be different or opposite according to embodiment. For example, a certain signal having a logic “high” level in one embodiment may be set to have a logic “low” level in another embodiment.

Various embodiments of the present disclosure will be described hereinafter in detail with reference to the accompanying drawings. However, the embodiments described herein are for illustrative purposes only and are not intended to limit the scope of the present disclosure.

Various embodiments are directed to normalizers for performing normalization and denormalization on floating point data, and an operation circuit including the same.

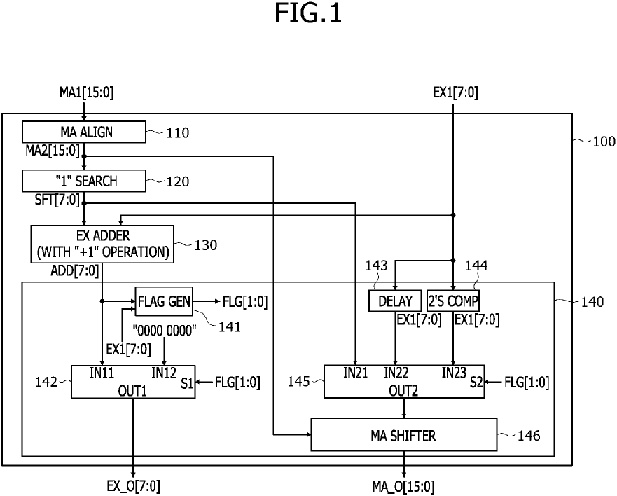

FIG. 1 is a diagram illustrating a normalizer 100 according to an embodiment of the present disclosure. Referring to FIG. 1, the normalizer 100 may perform normalization under normalization conditions to generate output data that is obtained by normalizing mantissa data of input data in the form of 1.xxx... (“x” being “0” or “1”). The normalizer 100 may also perform denormalization under denormalization conditions. Hereinafter, it will be exemplified that the input data includes 8-bit first exponent data EX1[7:0] and 16-bit first mantissa data MA1[15:0]. The input data may include 1-bit sign data, but the value of the sign data might not be changed by the normalization or denormalization of the normalizer 100. The normalizer 100 may perform normalization or denormalization on the input data to generate and output the output data including exponent data EX_O[7:0] and mantissa data MA_O[15:0]. The normalizer 100 may include a mantissa alignment circuit (MA ALIGN) 110, a “1” search circuit (“1” SEARCH) 120, an exponent addition circuit (EX ADDER) 130, and a normalization circuit 140.

The mantissa alignment circuit 110 of the normalizer 100 may receive the first mantissa data MA1[15:0] of the input data. The mantissa alignment circuit 110 may output second mantissa data MA2[15:0] that is generated by moving a binary point of the first mantissa data MA1[15:0] to the left by one bit. The second mantissa data MA2[15:0] that is output from the mantissa alignment circuit 110 may have the same number of bits as the first mantissa data MA1[15:0], but only the position of the binary point may be different. In an example, when the first mantissa data MA1[15:0] is “00.0000 0100 0101 10”, the binary point that is located between the fifteenth bit and the fourteenth bit of the first mantissa data MA1[15:0] may be moved to be located between the sixteenth bit and the fifteenth bit, and accordingly, the second mantissa data MA2[15:0]) may become “0.0000 0010 0010 110”. The second mantissa data MA2[15:0] that is output from the mantissa alignment circuit 110 may be transmitted to the “1” search circuit 120 and the normalization circuit 140.

The “1” search circuit 120 may search for an uppermost bit position of the leading “1” in the bit values of the second mantissa data MA2[15:0]. The “1” search circuit 120 may generate and output shift data SFT[7:0] based on the search result. Specifically, the “1” search circuit 120 may search for the position of the uppermost “1” of the second mantissa data MA2[15:0] to generate binary data of the number of bits to be shifted so that the second mantissa data MA2[15:0] has a format of “1.xxxx...”. When a shifting direction for the second mantissa data MA2[15:0] is the right direction, the “1” search circuit 120 may output the generated binary data as shift data SFT[7:0]. When the shifting direction for the second mantissa data MA2[15:0] is the left direction, the “1” search circuit 120 may output a 2′s complement of the generated binary data as the shift data SFT[7:0]. The shift data SFT[7:0] may have the same number of bits as the first exponent data EX1[7:0]. The shift data SFT[7:0] that is output from the “1” search circuit 120 may be transmitted to the exponent addition circuit 130 and the normalization circuit 140.

The exponent addition circuit 130 may perform an addition operation on the shift data SFT[7:0] that is output from the “1” search circuit 120 and the first exponent data EX1[7:0] and may perform a “+1” operation on the data that is generated from the addition operation to generate and output addition data ADD[7:0]. Because the shift data SFT[7:0] is binary data of the number of bits to be shifted to make the second mantissa data MA2[15:0] in the format of “1.xxxx...”, the data that is generated as a result of the addition operation on the first exponent data EX1[7:0] and the shift data SFT[7:0] may correspond to the first exponent data EX1[7:0] that is adjusted to make the first mantissa data MA1[15:0] in the format of “0.1xxx...”. By performing a “+1” operation on the addition result data, the addition data may be generated to correspond to the first exponent data that is adjusted by shifting the first mantissa data in the format of “1.xxxx...”. If the shift data SFT[7:0] is a negative number and rounding “1” occurs as a result of performing up to the “+1” operation, the exponent addition circuit 130 may output the remaining data from which carry “1” is deleted as the addition data ADD[7:0]. If the shift data SFT[7:0] is a negative number and rounding “1” does not occur as a result of performing up to the “+1” operation, the exponent addition circuit 130 may output the result data that is performed up to the “+1” operation as the addition data ADD[7:0]. The exponent addition circuit 130 may transmit the addition data ADD[7:0] to the normalization circuit 140.

The normalization circuit 140 may perform normalization when the addition data ADD[7:0] meets a normalization condition and may perform denormalization when the addition data ADD[7:0] meets a denormalization condition. If the addition data ADD[7:0] is greater than the decimal number “0”, the addition data ADD[7:0] may correspond to the normalization condition, and if the addition data ADD[7:0] is equal to or less than the decimal number “0”, the addition data ADD[7:0] may correspond to the denormalization condition. When the normalization circuit 140 performs the normalization, the addition data ADD[7:0] may be output as exponent data EX_O[7:0] of the output data. Result data that is obtained by shifting the second mantissa data MA2[15:0] by the number of bits that correspond to an absolute value of the shift data SFT[7:0] may be output as mantissa data MA_O[15:0] of the output data. When the normalization circuit 140 performs the denormalization processing, “0” may be output as exponent data EX_O[7:0] of the output data. The result data that is obtained by shifting the second mantissa data MA2[15:0] by the number of bits that correspond to the absolute value of the first exponent data EX1[7:0] may be output as mantissa data MA_O[15:0] of the output data.

The normalization circuit 140 may include a flag generator (FLAG GEN) 141, a first selector 142, a delay circuit (DELAY) 143, a 2′s complement circuit (2′S COMP) 144, a second selector 145, and a mantissa shifter (MA SHIFTER) 146. The flag generator 141 may receive the addition data ADD[7:0] that is output from the exponent addition circuit 130 and the first exponent data EX1[7:0]. The flag generator 141 may generate and output a flag signal FLG[1:0] having first to third flag values based on the addition data ADD[7:0] and a sign of the first exponent data EX1[7:0]. If the addition data ADD[7:0] is greater than the decimal number “0”, the flag generator 141 may output a flag signal FLG[1:0] of the first flag value that corresponds to the normalization condition, regardless of the sign of the first exponent data EX1[7:0]. If the addition data ADD[7:0] is less than or equal to the decimal number “0” and the first exponent data EX1[7:0] is a positive number, the flag generator 141 may output a flag signal FLG[1:0] of the second flag value that corresponds to the denormalization condition. If the addition data ADD[7:0] is equal to or smaller than “0” and the first exponent data EX1[7:0] is a negative number, the flag generator 141 may output a flag signal FLG[1:0] of the third flag value that corresponds to the denormalization condition. When the flag signal FLG[1:0] of the second flag value is generated, the shifting in the mantissa shifter 146 may be performed to shift in the left direction. On the other hand, when the flag signal FLG[1:0] of the third flag value is generated, the shifting in the mantissa shifter 146 may be performed to shift in the right direction. The flag generator 141 may transmit the flag signal FLG[1:0] to the first selector 142 and the second selector 143.

The first selector 142 may include a first input terminal IN11, a second input terminal IN12, a selection terminal S1, and an output terminal OUT1. In an embodiment, the first selector 142 may be configured with a multiplexer. The first selector 142 may receive the addition data ADD[7:0] that is output from the exponent addition circuit 130 through the first input terminal IN 11. The first selector 142 may fixedly receive a binary value of the decimal number “0”, that is, “0000 0000”, when the exponent data includes 8 bits as in this embodiment through the second input terminal IN12. The first selector 142 may receive the flag signal FLG[1:0] that is output from the flag generator 141 through the selection terminal S1. When the flag signal FLG[1:0] of the first flag value that corresponds to the normalization condition is received through the selection terminal S1, the first selector 142 may output the addition data ADD[7:0] that is received through the first input terminal IN11 as the exponent data EX_O[7:0] of the output data through the output terminal OUT1. When the flag signal FLG[1:0] of the second flag value or third flag value that corresponds to the denormalization condition is received, the first selector 142 may output the “0000 0000” that is received through the second input terminal IN12 as the exponent data EX_O[7:0] of the output data through the output terminal OUT1.

The delay circuit 143 and the 2′s complement circuit 144 may receive the first exponent data EX1[7:0], in common. The delay circuit 143 may output the first exponent data EX1[7:0] with a predetermined time delay. The 2′s complement circuit 144 may generate and output 2′s complement EX1_2C[7:0] of the first exponent data. The delay time in the delay circuit 143 may be set to a time that is required for the 2′s complement circuit 144 to generate the 2′s complement EX1_2C[7:0] of the first exponent data.

The second selector 145 may include a first input terminal IN21, a second input terminal IN22, a third input terminal IN23, a selection terminal S2, and an output terminal OUT2. The second selector 145 may receive the shift data SFT[7:0] that is output from the “1” search circuit 120 through the first input terminal IN21. The second selector 145 may receive the first exponent data EX1[7:0] that is output from the delay circuit 143 through the second input terminal IN22. The second selector 145 may receive the 2′s complement EX1_2C[7:0] of the first exponent data that is output from the 2′s complement circuit 144 through the third input terminal IN23. When the flag signal FLG[1:0] of the first flag value that corresponds to the normalization condition is received through the selection terminal S2, the second selector 145 may output the shift data SFT[7:0] that is received through the first input terminal IN21 through the output terminal OUT2. When the flag signal FLG[1:0] of the second flag value that corresponds to the denormalization and left shifting condition is received through the selection terminal S2, the second selector 145 may output the first exponent data EX1[7:0] that is transmitted from the delay circuit 143 through the output terminal OUT2. When the flag signal FLG[1:0] of the third flag value that corresponds to the denormalization and right shifting condition is received through the selection terminal S2, the second selector 145 may output the 2′s complement EX1_2C[7:0] of the first exponent data that is transmitted from the 2′s complement circuit 144 through the output terminal OUT2. The output data that is output from the second selector 145 may be transmitted to the mantissa shifter 146.

The mantissa shifter 146 may perform a shifting operation on the second mantissa data MA2[15:0] by the number of bits that correspond to an absolute value of the output data that is transmitted from the second selector 145 to generate and output mantissa data MA_O[15:0] of the output data. When positive shift data SFT[7:0] is transmitted from the second selector 145, the mantissa shifter 146 may perform a right shifting operation for the second mantissa data MA2[15:0] by the number of bits that correspond to an absolute value of the shift data SFT[7:0]. On the other hand, when negative shift data SFT[7:0] is transmitted from the second selector 145, the mantissa shifter 146 may perform a left shifting operation for the second mantissa data MA2[15:0] by the number of bits that correspond to the absolute value of the shift data SFT[7:0]. When the first exponent data EX1[7:0] is transmitted from the second selector 145, the mantissa shifter 146 may perform a left shifting operation for the second mantissa data MA2[15:0] by the number of bits that correspond to an absolute value of the first exponent data EX1[7:0]. When a 2′s complement EX1_2C[7:0] of the first exponent data is transmitted from the second selector 145, the mantissa shifter 146 may perform a right shifting operation for the second mantissa data MA2[15:0] by the number of bits that correspond to an absolute value of the 2′s complement EX1_2C[7:0] of the first exponent data.

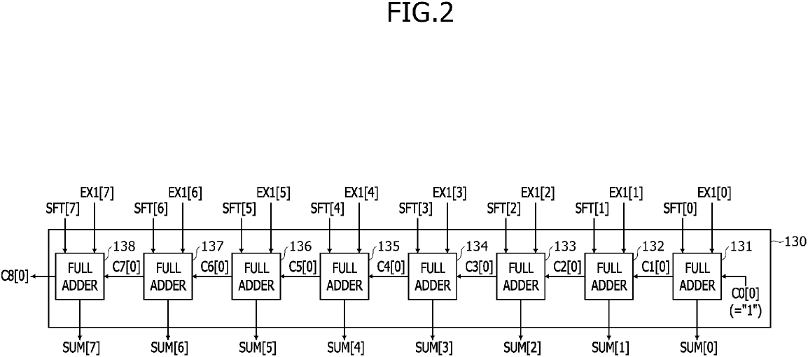

FIG. 2 is a diagram illustrating an example of a configuration of the exponent addition circuit 130 of the normalizer 100 of FIG. 1. Referring to FIG. 2, the exponent addition circuit 130 may include a plurality of full adders 131-138 that are interconnected to perform a parallel addition operation. The number of the full adders 131-138 may be the same as the number of bits of the first exponent data EX1[7:0]. Each of the full adders 131-138 may respectively receive each of the bits of the first exponent data EX1[7:0] through a first input terminal. Each of the full adders 131-138 may respectively receive each of the bits of the shift data SFT[7:0] through a second input terminal. Each of the full adders 131-138 may receive carry-in data C[0] through a third input terminal. Each of the full adders 131-138 may respectively output each bit of summation data SUM[7:0] through a first output terminal. Each of the full adders 131-138 may output carry-out data C[0] through a second output terminal. The carry-out data that is output from the second output terminal of the previous full adder may constitute the carry-in data that is input to the third input terminal of the next full adder. Accordingly, the terms carry-in data and carry-out data may represent the same carry data.

The first full adder 131 that receives a least significant bit (LSB) EX1[0] of the first exponent data and a least significant bit SFT[0] of the shift data may fixedly receive “1” as the carry-in data C0[0]. In this way, by fixedly inputting “1” as the carry-in data C0[0] to the first full adder 131, a “+1” operation may be performed in the exponent addition circuit 130 without additional logic. The first full adder 131 may add the least significant bit (LSB) EX1[0] of the first exponent data, the least significant bit SFT[0] of the shift data, and the carry-in data C0[0] “1” to output carry-output data C1[0] and a least significant bit SUM[0] of the summation data. The second full adder 132 may add a second bit EX1[1] of the first exponent data, a second bit SFT[1] of the shift data, and the carry-in data C1[0] from the first full adder 131 to output carry-out data C2[0] and a second bit SUM[1] of the summation data. The third to seventh full adders 133-137 may also perform addition operations in the same manner. The eighth full adder 138 may add a most significant bit (MSB) EX1[7] of the first exponent data, a most significant bit SFT[7] of the shift data, and carry-in data C7[0] from the seventh full adder 137 to output carry-out data C8[0] and a most significant bit SUM[7] of the summation data. When the shift data SFT[7:0] is a negative number and the carry-out data C8[0] is “1”, the exponent addition circuit 130 may output the summation data SUM[7:0] as the addition data ADD[7:0]. On the other hand, although not shown in FIG. 2, when the shift data SFT[7:0] is a negative number and the carry-out data C8[0] is “0”, the exponent addition circuit 130 may output the 2′s complement of the summation data sum[7:0] as the addition data ADD[7:0].

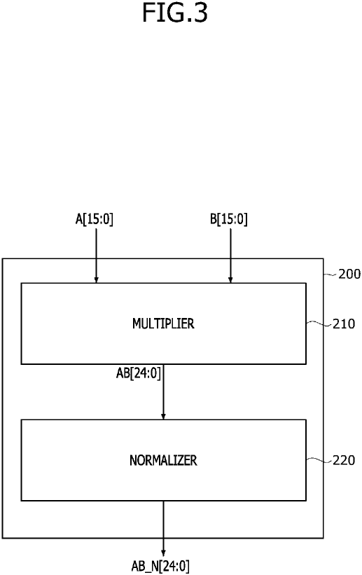

FIG. 3 is a diagram illustrating an operation circuit 200 according to an embodiment of the present disclosure. Referring to FIG. 3, the operation circuit 200 may include a multiplier 210 and a normalizer 220. The multiplier 210 may receive first input data A[15:0] and second input data B[15:0] and may perform a multiplication operation. The multiplier 210 may output multiplication data AB[24:0] that is generated as a result of the multiplication operation. In an embodiment, when each of the first input data A[15:0] and the second input data B[15:0] is in a standard format, for example, in the 16-bit brain floating-point (BF16) format, each of the first input data A[15:0] and the second input data B[15:0] may be composed of 1-bit sign data, 8-bit exponent data, and 7-bit mantissa data. Because a hidden bit is omitted in the 7-bit mantissa data, the 7-bit mantissa data may be transmitted to the multiplier 210 in the form of “1.xxxx xxx” including the hidden bit. In another embodiment, when at least one of the first input data A[15:0] and the second input data B[15:0] is not in a normalized format, the input data may be transmitted to the multiplier 210 in the form of “0.xxxx xxx”. The multiplication data AB[24:0] that is output from the multiplier 210 may be composed of 1-bit sign data, 8-bit exponent data, and 16-bit mantissa data. The normalizer 220 may receive the multiplication data AB[24:0] from the multiplier 210 and may perform normalization or denormalization to generate output data AB_N[24:0]. The configuration and operation of the normalizer 220 may be the same as those of the normalizer 100, described above with reference to FIG. 1, and thus, a redundant description thereof will be omitted.

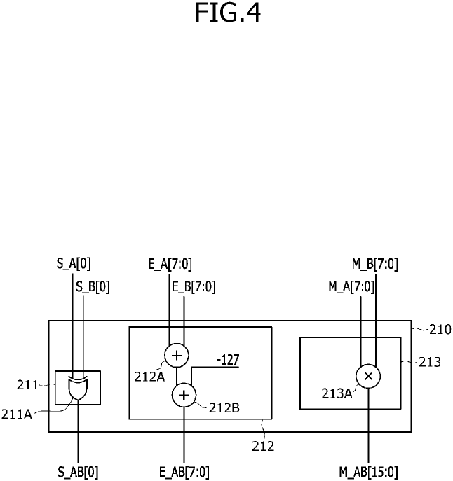

FIG. 4 is a diagram illustrating an example of a configuration of the multiplier 210 of the operation circuit 200 of FIG. 3. Referring to FIG. 4, the multiplier 210 may include a sign processing circuit 211, an exponent processing circuit 212, and a mantissa processing circuit 213. The sign processing circuit 211 may include an exclusive OR (hereinafter, referred to as “XOR”) gate 211A. The XOR gate 211A may receive sign data S_A[0] of the first input data (A[15:0] of FIG. 3) and sign data S_B[0] of the second input data (B[15:0] of FIG. 3). When both the sign data S_A[0] of the first input data (A[15:0] of FIG. 3) and the sign data S_B[0] of the second input data (B[15:0] of FIG. 3) have values of “0” that represent a positive number or have values of “1” that represent a negative number, the XOR gate 211A may output “0” that represents a positive number. On the other hand, one of the sign data S_A[0] of the first input data (A[15:0] of FIG. 3) and the sign data S_B[0] of the second input data (B[15:0] of FIG. 3) has a value of “0” that represents a positive number and the other has a value of “1” that represents a negative number, the XOR gate 211A may output “1” that represents a negative number. The XOR gate 211A may output data that is generated as a result of the XOR operation as the 1-bit sign data of the multiplication data (AB[24:0] of FIG. 3).

The exponent processing circuit 212 may include a first exponent adder 212A and a second exponent adder 212B. The first exponent adder 212A may receive exponent data E_A[7:0] of the first input data A[15:0] and exponent data E_B[7:0] of the second input data B[15:0]. The first exponent adder 212A may perform a first addition operation on the exponent data E_A[7:0] of the first input data A[15:0] and the exponent data E_B[7:0] of the second input data B[15:0]. The first exponent adder 212A may output first addition result data that is generated as a result of the first addition operation. Each of the exponent data E_A[7:0] of the first input data A[15:0] and the exponent data E_B[7:0] of the second input data B[15:0] may be in a state in which an exponent bias value, for example, “127” is added. As the exponent bias value is doubled by the first addition operation in the first exponent adder 212A, it is necessary to subtract the exponent bias value from the first addition result data. Accordingly, the second exponent adder 212B may receive the first addition result data that is output from the first exponent adder 212A and may perform an operation of subtracting the exponent bias value “127” from the first addition result data, that is, a second addition operation on the first addition result data and “-127”. The second exponent adder 212B may output data that is generated as a result of the second addition operation as the 8-bit exponent data E_AB[7:0] of the multiplication data AB[24:0].

The mantissa processing circuit 213 may include a mantissa multiplier 213A. The mantissa multiplier 213A may receive mantissa data M_A[7:0] of the first input data A[15:0] and mantissa data M_B[7:0] of the second input data B[15:0]. As mentioned above, when both the first input data A[15:0] and the second input data B[15:0] are in the BF16 format, both the mantissa data M_A[7:0] of the first input data A[15:0] and the mantissa data M_B[7:0] of the second input data B[15:0] may include a hidden bit and may be input to the mantissa multiplier 213A in the form of “1.xxxx xxx”. The mantissa multiplier 213A may perform a multiplication operation on the mantissa data M_A[7:0] of the first input data A[15:0] and the mantissa data M_B[7:0] of the second input data B[15:0]. The mantissa multiplier 213A may output data that is generated as a result of the multiplication operation as the 16-bit mantissa data M_AB[15:0] of the multiplication data AB[24:0]. When each of the mantissa data M_A[7:0] of the first input data A[15:0] and the mantissa data M_B[7:0] of the second input data B[15:0] that is input to the mantissa multiplier 213A is composed of “M” bits (“M” is a natural number) including a hidden bit, the mantissa data M_AB[15:0] of the multiplication data AB[24:0] that is output from the mantissa multiplier 212A may be composed of “2×(M+1)” bits, and the binary point in the mantissa data M_AB[15:0] of the multiplication data AB[24:0] may be located between a “2xM”^{th} bit and a “(2xM)+1”^{th} bit.

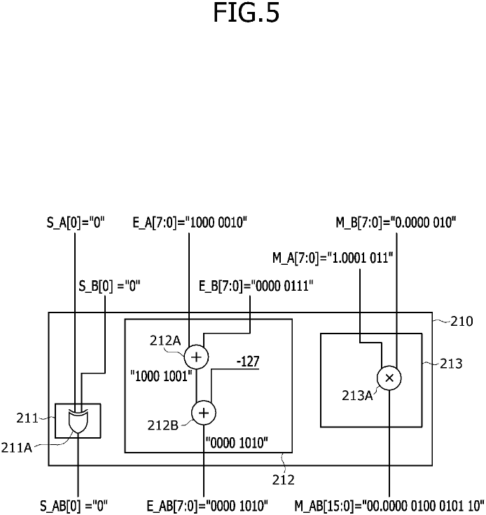

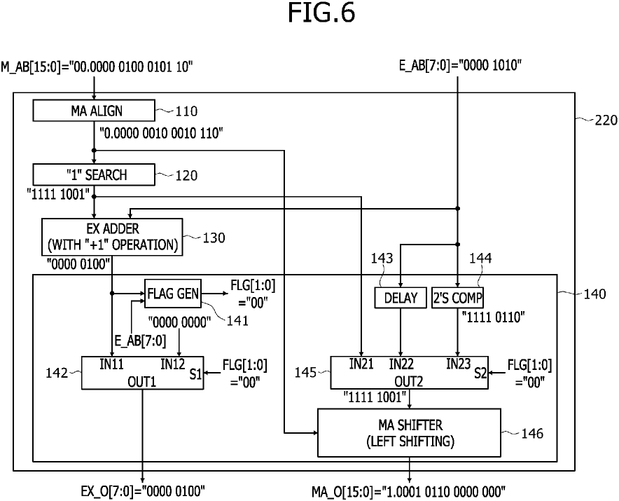

FIGS. 5 and 6 are diagrams illustrating an example of an operation of the operation circuit 200 of FIG. 3. In particular, FIGS. 5 and 6 are diagrams illustrating a case in which the normalizer 220 performs normalization in the operation of the operation circuit 200 of FIG. 3. FIG. 5 illustrates the operation of the multiplier 210 of the operation circuit 200 in this example, and FIG. 6 illustrates the operation of the normalizer 220. In this example, the sign data S_A[0] of the first input data A[15:0] may be “0”, the exponent data E_A[7:0] of the first input data A[15:0] may be “1000 0010”, the mantissa data M_A[7:0] of the first input data A[15:0] may be “1.0001 011”, the sign data S_B[0] of the second input data B[15:0] may be “0”, the exponent data E_B[7:0] of the second input data B[15:0] may be “0000 0111”, and the mantissa data M_B[7:0] of the second input data B[15:0] may be “0.0000 010”.

First, referring to FIG. 5, the XOR gate 211A of the multiplier 210 may perform an XOR operation on the sign data S_A[0] “0” of the first input data and the sign data S_B[0] “0” of the second input data. The XOR gate 211A may output “0”, which is a result of the XOR operation, as the sign data S_AB[0] of the multiplication data AB[24:0] that is output from the multiplier 210. The first exponent adder 212A may perform a first addition operation on the exponent data E_A[7:0] “1000 0010” of the first input data and the exponent data E_B[7:0] “0000 0111” of the second input data. The first exponent adder 212A may transmit data “1000 1001” that is generated as a result of the first addition operation to the second exponent adder 212B. The second exponent adder 212B may perform a second addition operation on the data “1000 1001” that is transmitted from the first exponent adder 212A and an exponent bias value “-127”. The second exponent adder 212B may transmit data “0000 1010” that is generated as a result of the second addition operation as the exponent data E_AB[7:0] of the multiplication data. The mantissa multiplier 213A may perform a multiplication operation on the mantissa data M_A[7:0] “1.0001 011” of the first input data and the mantissa data M_B[7:0] “0.0000 010” of the second input data. The mantissa multiplier 213A may output data “00.0000 0100 0101 10” that is generated as a result of the multiplication operation as the mantissa data M_AB[15:0] of the multiplication data.

Next, referring to FIG. 6, the normalizer 220 may receive the exponent data E_AB[7:0] “0000 1010” and the mantissa data M_AB[15:0] “00.0000 0100 0101 10” of the multiplication data AB[24:0] that are output from the multiplier (210 of FIG. 5). The mantissa alignment circuit 110 may output data “0.0000 0010 0010 110” with binary point that is shifted by one bit to the left in comparison to the mantissa data M_AB[15:0] “00.0000 0100 0101 10”. The “1” search circuit 120 may search for an uppermost bit position of the leading “1” in the data “0.0000 0010 0010 110” that is output from the mantissa alignment circuit 110. In the data “0.0000 0010 0010 110” that is output from the mantissa alignment circuit 110, the leading “1” may be located “7” bits away from the binary point. Accordingly, because the leading “1” needs to be shifted by “7” bits to the left such that the data “0.0000 0010 0010 110” has a format of “1.xxxx...”, the “1” search circuit 120 may generate the 2′s complement “1111 1001” of “0000 0111”, which is the binary value of “7”, and may output the “1111 1001” as shift data.

The exponent addition circuit 130 may perform an addition operation on the exponent data E_AB[7:0] “0000 1010” of the multiplication data and the shift data “1111 1001” that is output from the “1” search circuit 120 to generate addition operation result data “1000 0001 1”. The exponent addition circuit 130 may perform a “+1” operation on the addition operation result data “1000 0001 1” to generate data “1000 0010 0”. The ninth bit of the data “1000 0010 0” may correspond to the carry bit. As the carry bit “1” is generated, the exponent addition circuit 130 may output the remaining data “0000 0100” after the carry bit “1” has been deleted as the addition data. The exponent addition circuit 130 may transmit the addition data “0000 0100” to the flag generator 141 and the first input terminal IN11 of the first selector 142 of the normalization circuit 140.

The flag generator 141 of the normalization circuit 140 may generate and output a flag signal FLG[1:0] based on the addition data “0000 0100” that is transmitted from the exponent addition circuit 130. Because the addition data “0000 0100” is greater than the decimal number “0”, the flag generator 141 may generate and output a first flag value “00” that corresponds to the normalization condition as the flag signal FLG[1:0]. In response to the flag signal FLG[1:0] of “00” that is received through the selection terminal S1, the first selector 142 of the normalization circuit 140 may output the addition data “0000 0100” that is received through the first input terminal IN 11 as the exponent data EX_O[7:0] that is output from the normalizer 220.

The delay circuit 143 of the normalization circuit 140 may receive the exponent data E_AB[7:0] “0000 1010” and may output the exponent data E_AB[7:0] “0000 1010” with a predetermined time delay. The 2′s complement circuit 144 of the normalization circuit 140 may generate and output the 2′s complement “1111 0110” of the exponent data E_AB[7:0] “0000 1010”. The second selector 145 of the normalization circuit 140 may receive the “1111 1001” from the “1” search circuit 120, the “0000 1010” from the delay circuit 143, and the “1111 0110” from the 2′s complement circuit 144 through the first input terminal IN21, the second input terminal IN22, and the third input terminal IN23, respectively. In response to the flag signal FLG[1:0] of “00” that is received through the selection terminal S2, the second selector 145 may output the shift data “1111 1001” that is received through the first input terminal IN21 to transmit the shift data “1111 1001” to the mantissa shifter 146.

The mantissa shifter 146 of the normalization circuit 140 may perform a shifting operation on the data “0.0000 0010 0010 110” that is transmitted from the mantissa alignment circuit 110 by the number of bits that correspond to an absolute value of “1111 1001” that is transmitted from the second selector 145, that is, by “7” bits. In this case, because the shift data “1111 1001” that is transmitted from the second selector is a negative number, the shifting operation may be performed to shift in the left direction. The mantissa shifter 146 may output “1.0001 0110 0000 000” that is generated as a result of the shifting operation as the mantissa data MA_O[15:0] is output from the normalizer 220.

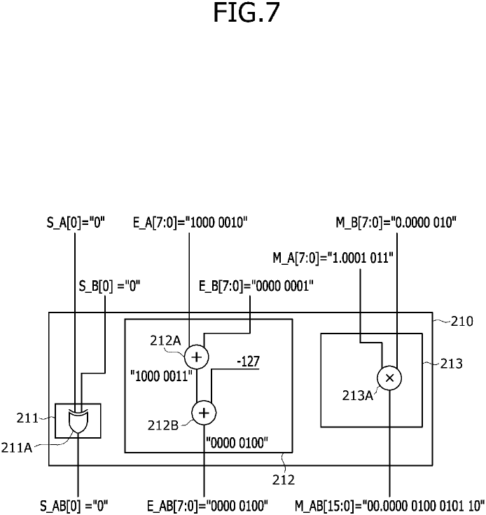

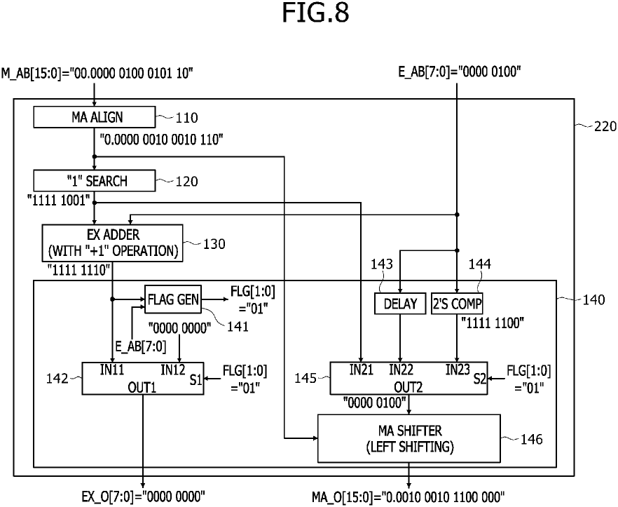

FIGS. 7 and 8 are diagrams illustrating another example of an operation of the operation circuit 200 of FIG. 3. In particular, FIGS. 7 and 8 are diagrams illustrating an example in which the mantissa shifter 146 performs a left shifting operation when the normalizer 220 performs the denormalization. FIG. 7 illustrates an operation of the multiplier 210 of the operation circuit 200 in this example, and FIG. 8 illustrates an operation of the normalizer 220. In this example, the sign data S_A[0] of the first input data A[15:0] may be “0”, the exponent data E_A[7:0] of the first input data A[15:0] may be “1000 0010”, the mantissa data M_A[7 :0] of the first input data A[15:0] is “1.0001 011”, the sign data S_B[0] of the second input data B[15:0] may be “0”, the exponent data E_B[7:0] of the second input data B[15:0] may be “0000 0001”, and the mantissa data M_B[7 :0] of the second input data B[15:0] may be “0.0000 010”.

First, referring to FIG. 7, the XOR gate 211A of the multiplier 210 may perform an XOR operation on the sign data S_A[0] “0” of the first input data and the sign data S_B[0] “0” of the second input data. The XOR gate 211A may output a result of the XOR operation “0” as the sign data S_AB[0] of the multiplication data AB[24:0] that is output from the multiplier 210. The first exponent adder 212A may perform a first addition operation on the exponent data E_A[7:0] “1000 0010” of the first input data and the exponent data E_B[7:0] “0000 0001” of the second input data. The first exponent adder 212A may transmit data “1000 0011” that is generated as a result of the first addition operation to the second exponent adder 212B. The second exponent adder 212B may perform a second addition operation on the data “1000 0011” that is transmitted from the first exponent adder 212A and an exponent bias value “-127”. The second exponent adder 212B may output data “0000 0100” that is generated as a result of the second addition operation as the exponent data E_AB[7:0] of the multiplication data. The mantissa multiplier 213A may perform a multiplication operation on the mantissa data M_A[7:0] “1.0001 011” of the first input data and the mantissa data M_B[7:0] “0.0000 010” of the second input data. The mantissa multiplier 213A may output data “00.0000 0100 0101 10” that is generated as a result of the multiplication operation as the mantissa data M_AB[15:0] of the multiplication data.

Next, referring to FIG. 8, the normalizer 220 may receive the exponent data E_AB[7:0] “0000 0100” and the mantissa data M_AB[15:0] “00.0000 0100 0101 10” of the multiplication data AB[24:0] that are output from the multiplier (210 of FIG. 7). The mantissa alignment circuit 110 may output data “0.0000 0010 0010 110” with a binary point that is shifted by “1” bit to the left in comparison to the mantissa data M_AB[15:0] “00.0000 0100 0101 10”. The “1” search circuit 120 may search for an uppermost bit position of the leading “1” in the data “0.0000 0010 0010 110” that is output from the mantissa alignment circuit 110. The leading “1” in the data “0.0000 0010 0010 110” that is output from the mantissa alignment circuit 110 may be located at a lower bit position by “7” bits from the binary point. Accordingly, because the leading “1” needs to be shifted by “7” bits to the left such that the data “0.0000 0010 0010 110” has a format of “1.xxxx...”, the “1” search circuit 120 may generate and output 2′s complement “1111 1001” of “0000 0111”, which is the binary value of “7” as shift data.

The exponent addition circuit 130 may perform an addition operation on the shift data “1111 1001” that is output from the “1” search circuit 120 and the exponent data E_AB[7:0] “0000 0100” of the multiplication data to generate addition operation result data “1111 1101”. The exponent addition circuit 130 may perform a “+1” operation on the addition operation result data “1111 1101” to generate data “1111 1110”. Because the data “1111 1110” does not include a carry bit “1”, the exponent addition circuit 130 may output the data “1111 1110” as addition data. The exponent addition circuit 130 may transmit the addition data “1111 1110” to the flag generator 141 and the first input terminal IN11 of the first selector 142 of the normalization circuit 140.

The flag generator 141 of the normalization circuit 140 may generate and output a flag signal FLG[1:0] based on the addition data “1111 1110” that is transmitted from the exponent addition circuit 130. Because the addition data “1111 1110” corresponds to a decimal value of “-2”, which is smaller than the decimal number “0”, the flag generator 141 may generate and output a second flag value “01” or a third flag value “10” that corresponds to the denormalization condition as the flag signal FLG[1:0]. In this example, because the exponent data E_AB[7:0] “0000 0100” is a positive number, the flag generator 141 may output the second flag value “01” as the flag signal FLG[1:0]. The first selector 142 of the normalization circuit 140 may output “0000 0000” that is input to the input terminal IN12 as the exponent data EX_O[7:0] that is output from the normalizer 220 in synchronization with the flag signal FLG[1:0] “01” that is received through the selection terminal S1.

The delay circuit 143 of the normalization circuit 140 may receive the exponent data E_AB[7:0] “0000 0100” and output the exponent data E_AB[7:0] “0000 0100” after delaying for a predetermined time period. The 2′s complement circuit 144 of the normalization circuit 140 may generate and output 2′s complement “1111 1100” of the exponent data E_AB[7:0] “0000 0100”. The second selector 145 of the normalization circuit 140 may receive the “1111 1001” from the “1” search circuit 120, the “0000 0100” from the delay circuit 143, and the “1111 1100” from the 2′s complement circuit 144 through the first input terminal IN21, the second input terminal IN22, and the third input terminal IN23, respectively. The second selector 145 may output shift data “0000 0100” that is received to the second input terminal IN22 to transmit the shift data “0000 0100” to the mantissa shifter 146 in response to the flag signal FLG[1:0] “01” that is received through the selection terminal S2.

The mantissa shifter 146 of the normalization circuit 140 may perform a shifting operation on the data “0.0000 0010 0010 110” that is transmitted from the mantissa alignment circuit 110 by the number of bits that correspond to an absolute value of the data “0000 0100” that is transmitted from the second selector 145, that is, by “4” bits. In this case, because the exponent data E_AB[7:0] “0000 0100” that is transmitted from the second selector 145 is input to the mantissa shifter 146, the shifting operation may be performed to shift in the left direction. The mantissa shifter 146 may output “0.0010 0010 1100 000” that is generated as a result of the shifting operation as the mantissa data MA_O[15:0] is output from the normalizer 220.

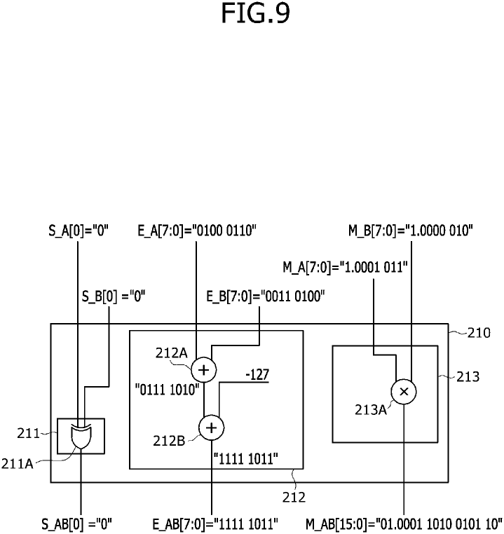

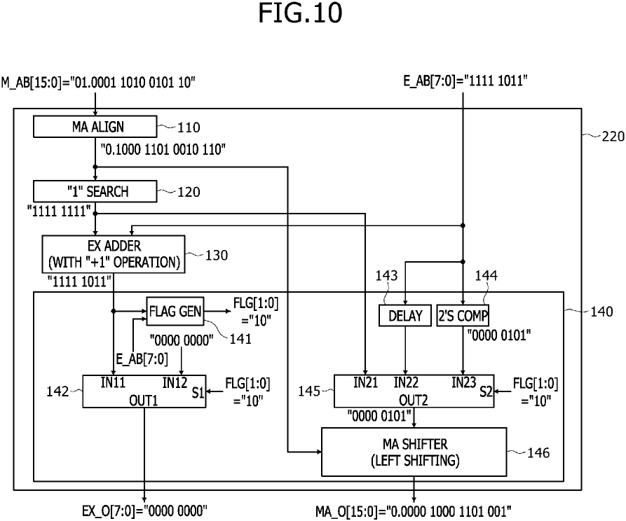

FIGS. 9 and 10 are diagrams illustrating further another example of an operation of the operation circuit 200 of FIG. 3. In particular, FIGS. 9 and 10 are diagrams illustrating an example in which the mantissa shifter 146 performs a right shifting operation when the normalizer 220 performs denormalization. FIG. 9 illustrates the operation of the multiplier 210 of the operation circuit 200 in this example, and FIG. 10 illustrates the operation of the normalizer 220 of the operation circuit 200. In this example, the sign data S_A[0] of first input data A[15:0] may be “0”, the exponent data E_A[7:0] of first input data A[15:0] may be “0100 0110”, the mantissa data M_A[7:0] of first input data A[15:0] may be “1.0001 011”, the sign data S_B[0] of second input data B[15:0] may be “0”, the exponent data E_B[7:0] of second input data B[15:0] may be “0011 0100”, and the mantissa data M_B[7:0] of second input data B[15:0] may be “1.0000 010”.

First, referring to FIG. 9, the XOR gate 211A of the multiplier 210 may perform an XOR operation on the sign data S_A[0] “0” of the first input data and the sign data S_B[0] “0” of the second input data. The XOR gate 211A may output a result of the XOR operation “0” as the sign data S_AB[0] of the multiplication data that is output from the multiplier 210. The first exponent adder 212A may perform a first addition operation on the exponent data E_A[7:0] “0100 0110” of the first input data and the exponent data E_B[7:0] “0011 0100” of the second input data. The first exponent adder 212A may transmit data “0111 1010” that is generated as a result of the first addition operation to the second exponent adder 212B. The second exponent adder 212B may perform a second addition operation on the data “0111 1010” that is transmitted from the first exponent adder 212A and an exponent bias value “-127”. The second exponent adder 212B may output data “1111 1011” that is generated as a result of the second addition operation as the exponent data E_AB[7:0] of the multiplication data. The mantissa multiplier 213A may perform a multiplication operation on the mantissa data M_A[7:0] “1.0001 011” of the first input data and the mantissa data M_B[7:0] “1.0000 010” of the second input data. The mantissa multiplier 213A may output “01.0001 1010 0101 10” that is generated as a result of the multiplication operation as the mantissa data M_AB[15:0] of the multiplication data.

Next, referring to FIG. 10, the normalizer 220 may receive the exponent data E_AB[7:0] “1111 1011” and the mantissa data M_AB[15:0] “01.00011010 0101 10” of the multiplication data AB[24:0] that are output from the multiplier (210 of FIG. 9). The mantissa alignment circuit 110 may output data “0.10001101 0010 110” with a binary point that is shifted by “1” bit to the left in comparison to the mantissa data M_AB[15:0] “01.0001 1010 0101 10”. The “1” search circuit 120 may search for an uppermost bit position of the leading “1” in the data “0.1000 1101 0010 110” that is output from the mantissa alignment circuit 110. The leading “1” in the data “0.1000 1101 0010 110” that is output from the mantissa alignment circuit 110 may be located at a lower bit position by “1” bit from the binary point. Accordingly, because the leading “1” needs to be shifted by “1” bit to the left such that the data “0.1000 1101 0010 110” has a format of “1.xxxx...”, the “1” search circuit 120 may generate and output 2′s complement “1111 1111” of “0000 0001”, which is the binary value of “1”, as the shift data.

The exponent addition circuit 130 may perform an addition operation on the exponent data E_AB[7:0] “1111 1011” of the multiplication data and the shift data “1111 1111” that is output from the “1” search circuit 120 to generate addition operation result data “1111 1101 0”. The exponent addition circuit 130 may perform a “+1” operation on the addition operation result data “1111 1101 0” to generate data “1111 1101 1”. As the data “1111 1101 1” includes a carry bit “1”, the exponent addition circuit 130 may remove the carry bit “1” from the data “1111 1101 1” and may output the remaining “1111 1011” as addition data. The exponent addition circuit 130 may transmit the addition data “1111 1011” to the flag generator 141 and the first input terminal IN11 of the first selector 142 of the normalization circuit 140.

The flag generator 141 of the normalization circuit 140 may generate and output the flag signal FLG[1:0] based on the mantissa data “1111 1011” that is transmitted from the exponent addition circuit 130 and the exponent data E_AB[7:0] “1111 1011”. The addition data “1111 1011” may correspond to a decimal number value of “-5”, which is smaller than the decimal number “0”, so that the flag generator 141 may generate and output a second flag value “01” or a third flag value “10” that corresponds to the denormalization condition as the flag signal FLG[1:0]. In this example, because the exponent data E_AB[7:0] “1111 1011” is a negative number, the flag generator 141 may output the third flag value “10” as the flag signal FLG[1:0]. The first selector 142 of the normalization circuit 140 may output “0000 0000” that is input to the second input terminal IN12 as the exponent data EX_O[7:0] that is output from the normalizer 220 in response to the flag signal FLG[1:0] of “10” that is received through the selection terminal S1.

The delay circuit 143 of the normalization circuit 140 may receive the exponent data E_AB[7:0] “1111 1011” and may output the exponent data E_AB[7:0] “1111 1011” after delaying for a predetermined time period. The 2′s complement circuit 144 of the normalization circuit 140 may generate and output 2′s complement “0000 0101” of the exponent data E_AB[7:0] “1111 1011”. The second selector 145 of the normalization circuit 140 may receive the “1111 1111” from the “1” search circuit 120, the “1111 1011” from the delay circuit 143, and the “0000 0101” from the 2′s complement circuit 144 through the first input terminal IN21, the second input terminal IN22, and the third input terminal IN23, respectively. The second selector 145 may output the 2′s complement “0000 0101” of the exponent data that is received through the third input terminal IN23 to transmit the 2′s complement “0000 0101” of the exponent data to the mantissa shifter 146 in response to the flag signal FLG[1:0] of “10” that is received through the selection terminal S2.

The mantissa shifter 146 of the normalization circuit 140 may perform a shifting operation on the “0.1000 1101 0010 110” that is transmitted from the mantissa alignment circuit 110 by the number of bits that correspond to an absolute value of “0000 0101” that is transmitted from the second selector 145, that is, by “5” bits. In this case, because the 2′s complement “0000 0101” of the exponent data that is transmitted from the second selector 145 is input to the mantissa shifter 146, the shifting operation may be performed to shift in the right direction. The mantissa shifter 146 may output “0.0000 1000 1101 00” that is generated as a result of the shifting operation as mantissa data MA_O[15:0] is output from the normalizer 220.

According to various embodiments of the present disclosure, there is an advantage that the total circuit area of the normalizer can be reduced by not requiring an adder that is used to generate shift data for shifting the mantissa data in the denormalization process for floating-point data.

A limited number of possible embodiments for the present teachings have been presented above for illustrative purposes. Those of ordinary skill in the art will appreciate that various modifications, additions, and substitutions are possible. While this patent document contains many specifics, these should not be construed as limitations on the scope of the present teachings or of what may be claimed, but rather as descriptions of features that may be specific to particular embodiments. Certain features that are described in this patent document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

What is claimed is:

1. A normalizer receiving input data including first exponent data and first mantissa data and generating normalized output data, the normalizer comprising:
a mantissa alignment circuit configured to output second mantissa data, a binary point of the second mantissa data being shifted by one bit to the left in comparison to a binary point of the first mantissa data;
a “1” search circuit configured to search for an uppermost bit position of a leading “1” in the second mantissa data to output shift data;
an exponent addition circuit configured to perform an addition operation on the shift data and the first exponent data and configured to perform a “+1” operation on a result of the addition operation to output addition data; and
a normalization circuit configured to perform normalization by outputting the addition data as exponent data of the output data and by outputting result data that is obtained by shifting the second mantissa data by the number of bits that correspond to an absolute value of the shift data as mantissa data of the output data.

2. The normalizer of claim 1, wherein the “1” search circuit is configured to output the shift data including the same number of bits as the first exponent data.

3. The normalizer of claim 1, wherein the “1” search circuit is configured to:
search for the uppermost bit position of the leading “1” in the second mantissa data to generate binary data of the number of bits to be shifted so that the second mantissa data has a format of “1.xxx...” (x is “0” or “1”); and
output the binary data or 2′s complement of the binary data as the shift data.

4. The normalizer of claim 3, wherein the “1” search circuit is configured to:
output the binary data as the shift data when a shifting operation for the second mantissa data is performed to shift in a right direction, and
output the 2′s complement of the binary data as the shift data when the shifting operation for the second mantissa data is performed to shift in a left direction.

5. The normalizer of claim 1, wherein the exponent addition circuit includes a plurality of full adders that are interconnected to each other to perform a parallel addition operation, the exponent addition circuit performing the “+1” operation by fixing “1” as carry-in data of the full adder of a least significant bit, among the plurality of full adders.

6. The normalizer of claim 5, wherein the exponent addition circuit is configured to:
output summation data that is output from the plurality of full adders as the addition data when the shift data is a negative number and carry-out data of the full adder of a most significant bit, among the plurality of full adders, is “1”, and
output 2′s complement of the summation data that is output from the plurality of full adders as the addition data with sign data that represents a negative number when the shift data is a negative number and the carry-out data of the full adder of the most significant bit, among the plurality of full adders, is “0”.

7. The normalizer of claim 1, wherein the normalization circuit is configured to perform the normalization when the addition data is greater than “0”.

8. The normalizer of claim 1, wherein the normalization circuit is configured to perform the normalization by performing a shifting operation to shift in a left direction for the second mantissa data.

9. The normalizer of claim 1, wherein the normalization circuit is configured to perform denormalization by outputting “1” as the exponent data of the output data and by outputting result data that is obtained by shifting the second mantissa data by the number of bits that correspond to an absolute value of the first exponent data as the mantissa data of the output data.

10. The normalizer of claim 9, wherein the normalization circuit is configured to perform the denormalization when the addition data is less than or equal to “0”.

11. The normalizer of claim 1, wherein the normalization circuit is configured to:
perform the denormalization by performing a shifting operation to shift in a left direction for the second mantissa data when the first exponent data is a positive number, and
perform the denormalization by performing a shifting operation to shift in a right direction when the first exponent data is a negative number.

12. The normalizer of claim 1, wherein the normalization circuit includes:
a first selector configured to receive the addition data through a first input terminal, to receive “0” through a second input terminal, and to output the addition data or the “0” as the exponent data of the output data through an output terminal;
a second selector configured to receive the shift data through a first input terminal, to receive the first exponent data through a second input data, to receive 2′s complement of the first exponent data through a third input terminal, and to output one of the shift data, the first exponent data, and the 2′s complement of the first exponent data through an output terminal; and
a mantissa shifter configured to perform a shifting operation for the second mantissa data by the number of bits that correspond to an absolute value of output data of the second selector to output the mantissa data of the output data.

13. The normalizer of claim 12, wherein the normalization circuit further includes a 2′s complement unit configured to perform 2′s complement processing on the first exponent data to transmit the 2′s complement of the first exponent data to the third input terminal of the second selector.

14. The normalizer of claim 12, wherein the normalization circuit further includes a flag generator configured to generate and output a flag signal having one of first to third flag values based on the addition data that is output from the exponent addition circuit.

15. The normalizer of claim 14, wherein the flag generator is configured to output a flag signal having the first flag value when the addition data is greater than “0”, to output a flag signal having the second flag value when the addition data is less than or equal to “0” and the first exponent data is a positive number, and to output a flag signal having the third flag value when the addition data is less than or equal to “0” and the first exponent data is a negative number.

16. The normalizer of claim 15,
wherein the first selector includes a first selection terminal capable of receiving the flag signal that is output from the flag generator and is configured to output the addition data as the exponent data of the output data through the output terminal when the flag signal has the first flag value and to output “0” as the exponent data of the output data when the flag signal has the second flag value or the third flag value.

17. The normalizer of claim 15,
wherein the second selector includes a second selection terminal capable of receiving the flag signal that is output from the flag generator and is configured to output the shift data through the output terminal when the flag signal has the first flag value, to output the first exponent data through the output terminal when the flag signal has the second flag value, and to output the 2′s complement of the first exponent data when the flag signal has the third flag value.

18. The normalizer of claim 17, wherein the mantissa shifter is configured to:
perform, when the shift data is transmitted from the second selector, a shifting operation to shift in a right direction for the second mantissa data by the number of bits that correspond to the absolute value of the shift data when the shift data is a positive number and perform a shifting operation to shift in a left direction for the second mantissa data by the number of bits that correspond to the absolute value of the shift data when the shift data is a negative number,
perform a shifting operation to shift in a left direction by the number of bits that correspond to the absolute value of the first exponent data when the first exponent data is transmitted from the second selector, and
perform a shifting operation to shift in a right direction by the number of bits that correspond to the absolute value of the first exponent data when the 2′s complement of the first exponent data is transmitted from the second selector.
